(19) United States
(12) Patent Application Publication
(10) Pub. No.: US 2019/0079198 A1
(43) Pub. Date: Mar. 14, 2019

(54) Tracking System for Use in Bow Hunting and Related Sporting Applications

(71) Applicant: Robert E. Lamar, Burlington, NC (US)

(72) Inventor: Robert E. Lamar, Burlington, NC (US)

(73) Assignee: Robert E. Lamar, Burlington, NC (US)

(21) Appl. No.: 16/125,952

(22) Filed: Sep. 10, 2018

Related U.S. Application Data
(60) Provisional application No. 62/556,722, filed on Sep. 11, 2017.
(60) Provisional application No. 62/702,540, filed on Jul. 24, 2018.

(51) Int. Cl. G01S 19/19; F42B 12/36

(52) U.S. Cl. CPC G01S 19/19; F42B 12/362

(57) ABSTRACT

A tracking system for tracking moving objects is provided. The system includes a position module configured to attach to an object that moves, the position module having a size that does not impede a purpose of the object that moves; and a tracking module that communicates with the position module and receives position information associated with the position module attached to the object that moves. Related position modules are also provided.

### CLAIM OF PRIORITY

The present application claims priority to U.S. Provisional Application Ser. No. 62/556,722 filed on Sep. 11, 2017 and U.S. Provisional Application Ser. No. 62/702,540, filed on Jul. 24, 2018, the contents of which are hereby incorporated herein by reference as if set forth in its entirety.

### BACKGROUND

Hunters spend hours waiting to see the object of their hunt within striking distance. Hunters use various types of weapons, for example, guns and crossbows. When the hunter finally locates the target, for example, a deer, bear, moose and the like, many times the weapon used only wounds the target and, therefore, does not fully incapacitate the target. The wounded animal often flees to avoid capture by the hunter. No hunter wants to send a wounded animal back into the woods to suffer and die rendering the loss of life useless as the animal meat would be wasted.

Existing systems and methods for tracking wounded prey, for example, a Pro Tracker system, may be unreliable. In bow hunting, use of the Pro Tracker may disrupt a flight pattern of a mechanical broadhead. The transmitter/receiver system is relatively cumbersome. Accordingly, improved methods of tracking animals that have been wounded, but not incapacitated by are needed.

### SUMMARY

Some embodiments of the present inventive concept provide a tracking system for tracking moving objects. The system includes a position module configured to attach to an object that moves, the position module having a size that does not impede a purpose of the object that moves; and a tracking module that communicates with the position module and receives position information associated with the position module attached to the object that moves.

In further embodiments, the position module may be positioned on an arrow and the position module may be configured to attach to the object that moves when the arrow penetrates the object that moves.

In still further embodiments, the object that moves may be a living thing and the position module may further include a tranquilizer to subdue the living thing.

In some embodiments, the position module may include a collar that is configured to be positioned around a shaft of the arrow.

In further embodiments, the position module may be positioned in a fletching of the arrow.

In still further embodiments, the object that moves may be a fish and the position module may be attached to the fish using a biodegradable fastening.

In some embodiments, the position module may be a global positioning system (GPS) module.

In further embodiments, the object that moves may be an object used in a sport.

In still further embodiments, the system may further include a portable electronic device that communicates with the tracking module and the position information may be displayed on the portable electronic device.

In some embodiments, the position information may be displayed on a map on the portable electronic device.

In further embodiments, the tracking module may be provided by a software application on the portable electronic device.

Still further embodiments of the present inventive concept provide a position module for use in a system for tracking moving objects, the position module comprising a housing having a size that does not impede a purpose of an object that moves and being configured to attach to the object that moves to provide position information associated with the object that moves.

### BRIEF DESCRIPTION OF THE DRAWINGS

FIG. 1 is a diagram illustrating a hunter and a target in a crossbow hunting scenario in accordance with some embodiments of the present inventive concept.

FIG. 2A is a block diagram illustrating a tracking system in accordance with some embodiments of the present inventive concept.

FIG. 2B is a more detailed block diagram illustrating a tracking system in accordance with some embodiments of the present inventive concept.

FIG. 3 is a map including a hunter and a moving target in accordance with some embodiments of the present inventive concept.

FIG. 4A is an image illustrating an assembled broadhead with blades engaged in accordance with some embodiments of the present inventive concept.

FIG. 4B is an image illustrating the body and tip of a broadhead in accordance with some embodiments of the present inventive concept.

FIG. 4C is an image illustrating the blades of a broadhead in accordance with some embodiments of the present inventive concept.

FIG. 4D is an image of the body of a broadhead with a locator collar in accordance with some embodiments of the present inventive concept.

FIG. 4E is an image of the collar and a penny to show relative size in accordance with some embodiments of the present inventive concept.

FIG. 5A is a diagram of an arrow in accordance with some embodiments of the present inventive concept.

FIG. 5B is a more detailed diagram of an arrow in accordance with some embodiments of the present inventive concept.

FIG. 6 is a table illustrating parameters and specifications for a global positioning (GPS) module in accordance with some embodiments of the present inventive concept.

FIG. 7 is a table illustrated details with respect to various parameters in accordance with embodiments of the present inventive concept.

FIG. 8 is a diagram of a fish illustrating placement of a position module in accordance with some embodiments of the present inventive concept.

FIG. 9 is a diagram of a portable electronic device including a map indicating location in accordance with some embodiments of the present inventive concept.

### DETAILED DESCRIPTION

The inventive concept now will be described more fully hereinafter with reference to the accompanying drawings, in which illustrative embodiments of the inventive concept are shown. This inventive concept may, however, be embodied in many different forms and should not be construed as limited to the embodiments set forth herein; rather, these embodiments are provided so that this disclosure will be thorough and complete, and will fully convey the scope of the inventive concept to those skilled in the art. Like numbers refer to like elements throughout. As used herein, the term “and/or” includes any and all combinations of one or more of the associated listed items.

As used herein, the singular forms “a”, “an” and “the” are intended to include the plural forms as well, unless expressly stated otherwise. It will be further understood that the terms “includes,” “comprises,” “including” and/or “comprising,” when used in this specification, specify the presence of stated features, integers, steps, operations, elements, and/or components, but do not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. Furthermore, “connected” or “coupled” as used herein may include wirelessly connected or coupled. As used herein, the term “and/or” includes any and all combinations of one or more of the associated listed items.

Unless otherwise defined, all terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

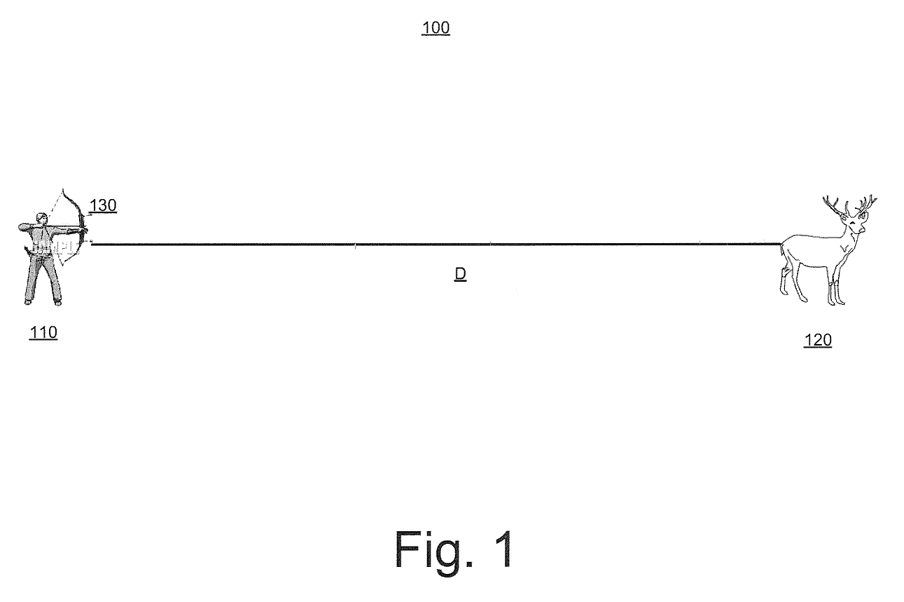

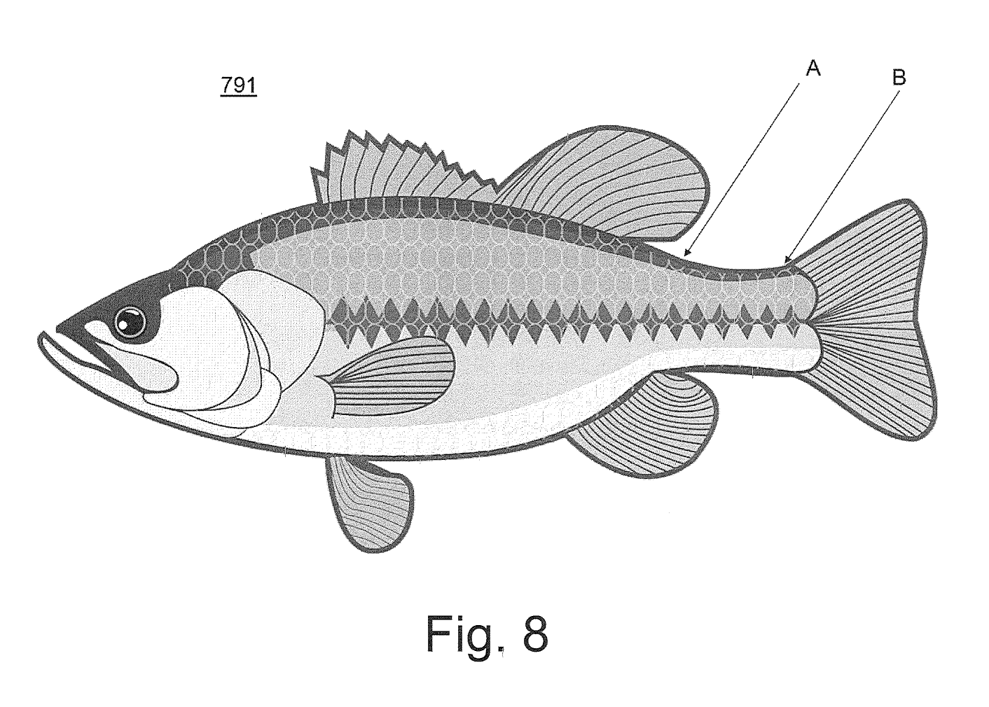

As discussed above, tracking systems and methods for bow hunters may be unreliable, may disrupt a flight pattern of an arrow head and the transmitter/receiver system may be cumbersome. Thus, some embodiments of the present inventive concept provide a device coupled to the broadhead that communicates with an application that can be run on a portable electronic device, for example, a smart phone or electronic surface. Accordingly, some embodiments of the present inventive concept may provide more reliable and convenient methods and systems of tracking a wounded animal as discussed further below with respect to FIGS. 1 through 9.

It will be understood that although embodiments of the present inventive concept are discussed herein with respect to hunting and specifically bow hunting, embodiments of the present inventive concept are not limited to this configuration. For example, a tracking system in accordance with embodiments discussed herein may be used to track other moving animals and/or objections. For example, in some embodiments the tracking system may be used to track fish or golf balls without departing from the scope of the present inventive concept.

Bow hunters generally have an effective range specific to the hunter, or more appropriately put, a maximum shooting distance that lies within their comfort zone. For some, it may be 30 yards, for others 60 or more. Similarly, the bows themselves also have an effective range and draw weight. The effective range may be defined as the distance at which the bow is capable of lethally delivering an arrow. Draw weight is a peak amount of weight an archer/hunter will pull while drawing the bow. With a traditional bow, the draw weight generally continues to increase as the bow is drawn. With a compound bow, the draw weight generally increases to the peak weight, and then drops in weight to the holding weight. Most compound bows are adjustable over a 10- to 15-pound range. For example, a 40-pound draw-weight compound bow can generally effectively kill a deer. As a rule of thumb, 40 pounds of kinetic energy efficiently kills whitetails, and 50 pounds or greater may be required for larger game, such as elk, moose, bear and the like.

As used herein, “target” refers to an animal being hunted or tracked or a moving object being tracked for embodiments directed to moving objects rather than animals. The animal can be any animal without departing from the scope of the present inventive concept. The effective range and draw weight of the compound bow may be selected based on the type of animal being hunted.

Referring now to FIG. 1, a typical scenario for hunting with a compound crossbow 130 will be discussed. As illustrated in FIG. 1, the scenario 100 includes a hunter 110 and a target 120, for example, a deer at a distance D from the hunter 110. As discussed above, an effective distance D can vary based on the hunter and/or the bow. It will be understood that the crossbow 130 can be any crossbow known to those having skill in the art and it is assumed that the hunter 110 is the appropriate size to use the selected crossbow 130. Assuming the distance D is at least 30 yards, if the hunter 110 releases the arrow and wounds, but does not kill, the target 120, the target may evade capture by the hunter 110 because the hunter cannot cover the 30 yards fast enough to catch the animal. Thus, the hunter 110 must pursue the wounded animal. It will be understood that although the environment in the scenario 100 of FIG. 1 is not illustrated with obstacles such as trees, bushes, lakes, ponds, rocks etc. between the hunter 110 and the target 120, there likely will be obstacles in a real hunting scenario. Accordingly, it may be relatively easy for the wounded animal to escape capture by the hunter 110 and hide among the elements.

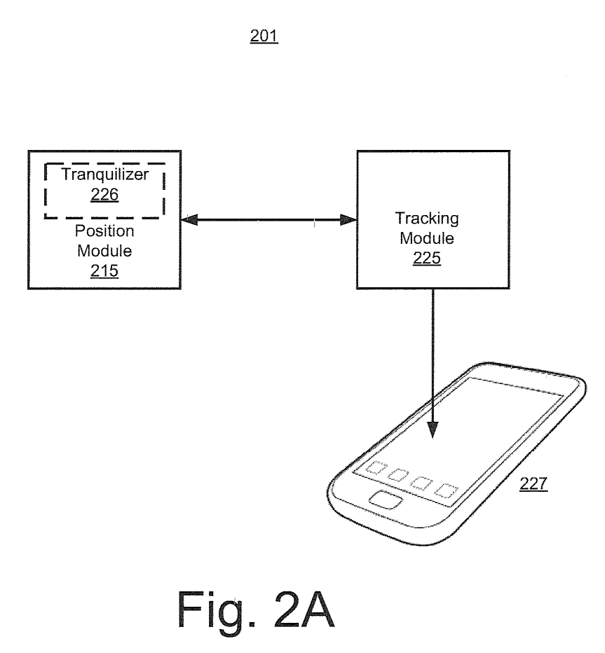

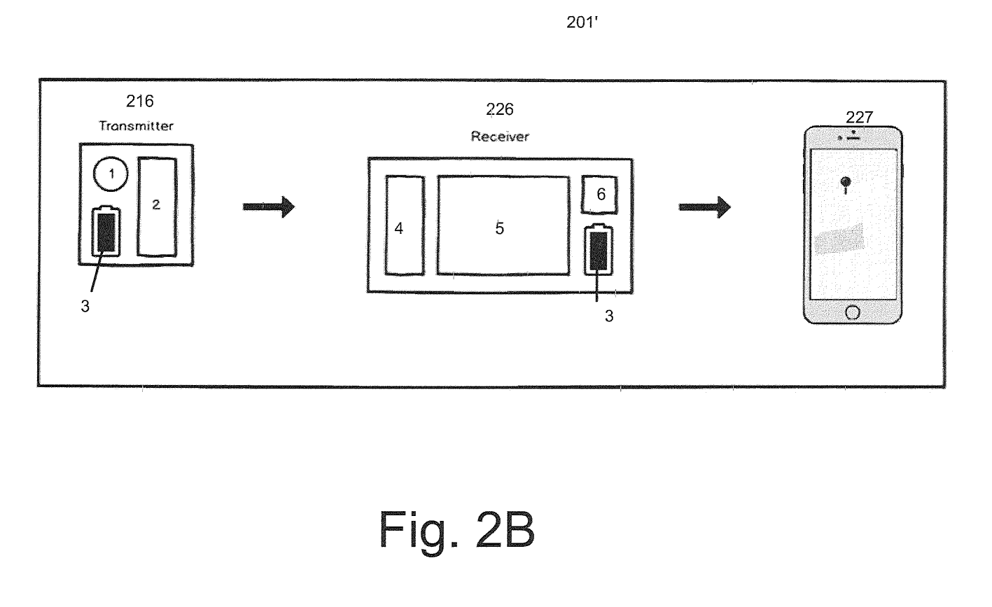

Accordingly, some embodiments of the present inventive concept provide methods and systems that allow the wounded animal to be tracked so that the animal does not suffer and the meat will not be wasted. Referring to FIG. 2A, a simple block diagram of a tracking system 201 in accordance with some embodiments will be discussed. As illustrated therein, the system 201 includes both a position module 215 and a tracking module 225. The position module 215 includes a transmitter and/or receiver that is physically coupled to some portion of the arrow that is shot at the target. For example, in some embodiments, the position module 215 may be a transmitter that is positioned on the broadhead and communicates with the tracking module 225 (receiver). Using the transmitted signals from the position module 215, the tracking module 225 can be used to locate the wounded animal.

As further illustrated in FIG. 2A, in some embodiments, the position module 215 may include a tranquilizer component 226. The optional nature of the tranquilizer component is indicated by the dotted lines. For example, in some embodiments, the position module 215 may be laced with a tranquilizer, which may slow the wounded target down as it is being tracked with the tracking module 225.

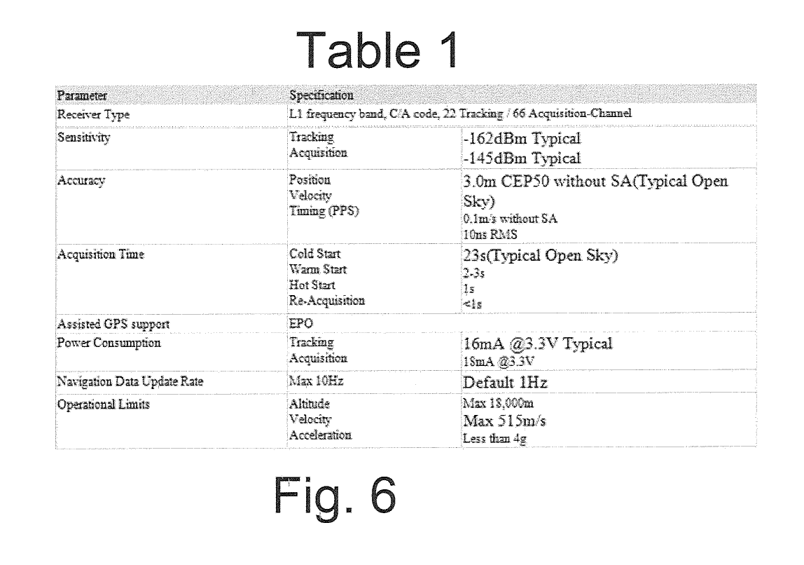

In some embodiments, the position module 215 may be a global positioning system (GPS) module that is small enough to be positioned on the arrow. When the arrow penetrates the target, the GPS module stays with the animal and transmits position information to the tracking module 225. In some embodiments, the GPS module may be an Ultra High Sensitive and Low Power GPS receiver. Parameters and specifications for an example GPS are illustrated in Table A in FIG. 6. It will be understood that the GPS module in accordance with embodiments discussed herein are not limited to the parameters and specifications provided in Table A. Any GPS module suitable for use with embodiments discussed herein can be used without departing from the scope of the present inventive concept.

The tracking module 225 is configured to receive the position information from the position module 215 (GPS module) and provide this information in the form a map to allow the hunter to track the wounded animal. In some embodiments, the tracking module 225 may be provided as an application on a portable electronic device 227, for example, a smart phone. Coupling the tracking module 225 with the smart phone decreases the number of “things” the hunter carries on his hunting excursion.

A more detailed block diagram of a tracking system 201′ in accordance with some embodiments will be discussed. As discussed above, the tracking system 201′ provides a detachable tracking system that may be attached to an arrow (or object) for tracking and locating the target of object of interest, for example, a wounded animal. The battery powered transceiver transmits location information provided by the GPS to allow the hunter to locate the wounded animal.

In particular, as illustrated in FIG. 2B, the system 201′ includes a transmitter 216, a receiver 226 and portable electronic device 227. The transmitter 216 includes a GPS module 1, a radio frequency (RF) transmitter 2 and a battery 3. The transmitter 216 may be an HC-12 transceiver in some embodiments that is powered by the battery 3. The GPS module 1 provides geolocation information, such as latitude, longitude and time, associated with the objects of interest on or above the surface of earth. The transmitter 216 relays the geolocation information to the receiver 226.

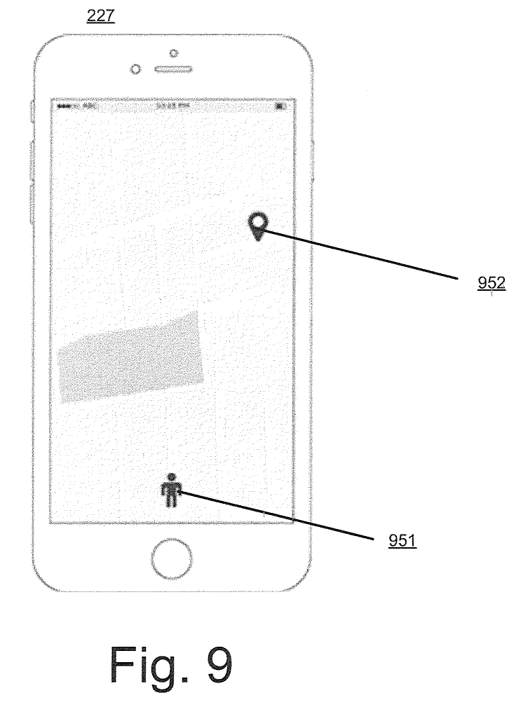

The receiver 226 includes an RF receiver 4, a controller 5 and a wireless module 6. The RF receiver 4 may be an HC-12 transceiver in some embodiments. The RF receiver 4 receives the geolocation information from the transmitter 216. The receiver 4 is connected to the controller 5, which decodes the received geolocation information. The geolocation information is sent to the portable electronic device 227 using the wireless module 6, for example, Wi-Fi or Bluetooth, and the portable electronic device 227 displays the location of the object of interest, for example, on a map. The portable electronic device 227 includes an application running thereon used to show the object of interest thereon as illustrated in, for example, FIG. 9.

Referring to FIG. 9, a portable electronic device running a software application in accordance with embodiments of the present inventive concept will be discussed. As illustrated in FIG. 9, a map illustrating a location of a user 951 and the object being tracked 952 is illustrated on the portable electronic device. The map depicted on the portable electronic device 227 is a street environment, however, embodiments of the present inventive concept are not limited to this configuration. Furthermore, more than one user's location data may be displayed without departing from the scope of the present inventive concept.

In particular, in some embodiments, the software application may provide a social media aspect to the outing. For example, in some embodiments, you may be able to see your friends and their targets on the application running on your portable electronic device or your smart phone. The application may distinguish between participants by using different colors or icons to differentiate between them on a display. A texting or messaging function may also be included to keep in touch during the outing.

In some embodiments, the software application may be a front-end client, which talks with the hardware interface of the tracking system. The software application may be configured to run on any type of device including both Android and iOS devices. As illustrated in FIG. 9, in combination with the portable electronic device 227, the software application will display the location of the target 952 or object of interest and of the user 951. In some embodiments, the software application receives the location data (latitude and longitude data) from the position module 215 and translates the location date for the map displayed on the portable electronic device.

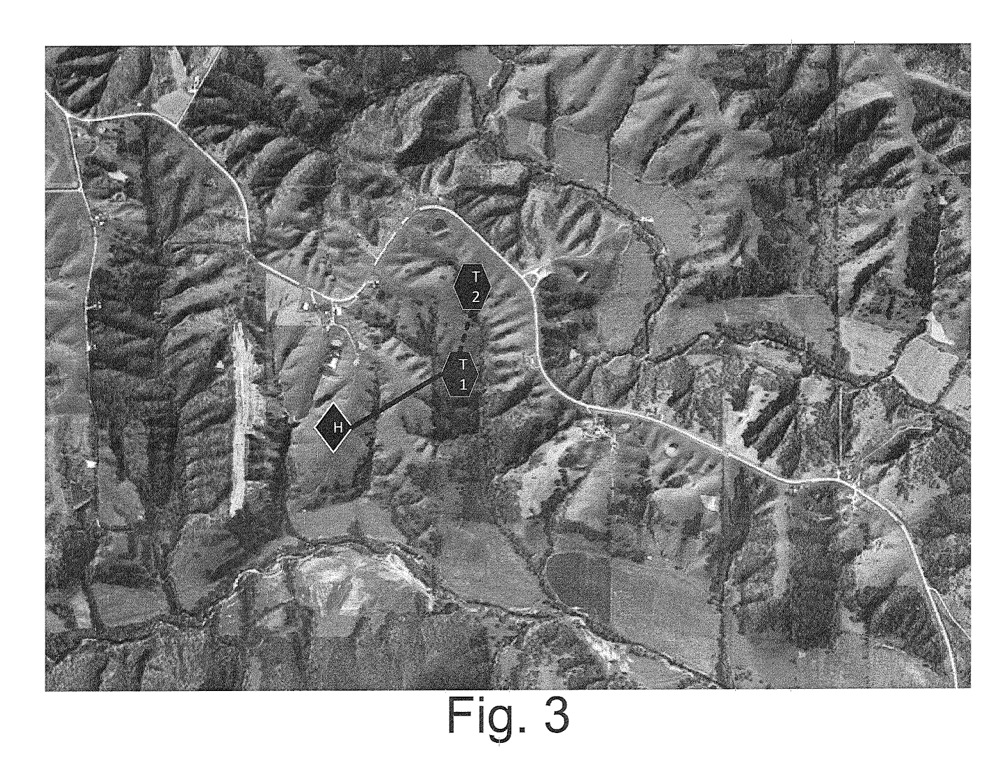

An example method of the functionality of the tracking system 201 will now be discussed with respect to FIGS. 2A and 3. FIG. 3 is a map of an area where a hunter may be hunting with a compound bow. As illustrated in FIG. 3, the hunter H may release the arrow and hit the target T at position T1, a distance away from the hunter H. Once the arrow engages with the animal, the position module 215 may transmit position information to the hunter H on the hunter's tracking module 225 that may be incorporated with the hunter's portable electronic device, for example, smart phone 227. Use of the tracking module 225 allows the hunter to receive the location information from the position module 215, now affixed to the target, and track the target from a first position T1 to a second position T2 as illustrated in FIG. 3.

As will discussed further below, the position module 215 (GPS module) may be attached to the target by any means known to those having skill in the art. For example, the GPS module may be positioned in a break away tip of the broadhead; inside a closed broadhead and released when the broadhead opens inside the target; on a location collar positioned around a body of the broadhead and/or on the fletch of the arrow to make sure the animal can be tracked if the arrow goes completely through the target.

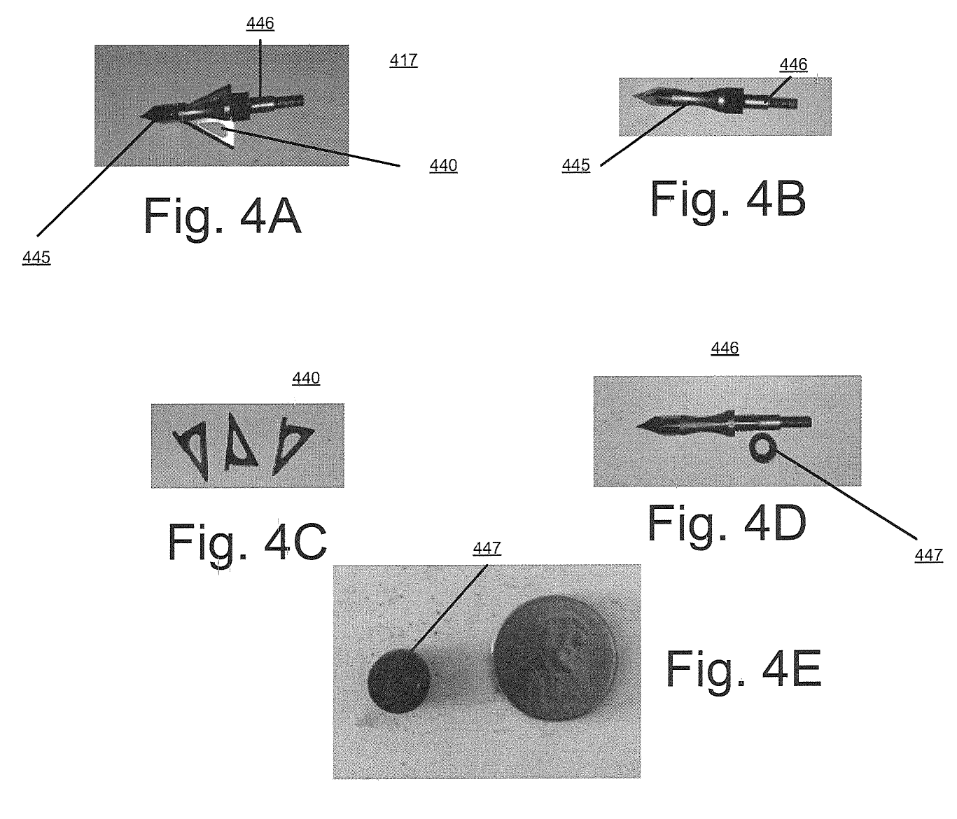

Example embodiments of a broadhead and locator collar will now be discussed with respect to FIGS. 4A through 4E in accordance with embodiments of the present inventive concept. FIG. 4A illustrate images of an assembled broadhead with blades engaged; FIG. 4B illustrates an image of the body and tip of the broadhead; FIG. 4C illustrates an image illustrating just blades of the broadhead; and FIG. 4D is an image of the body of the broadhead with a locator collar in accordance with some embodiments of the present inventive concept. FIG. 4E illustrates the locator collar with a penny to show relative size of the locator collar.

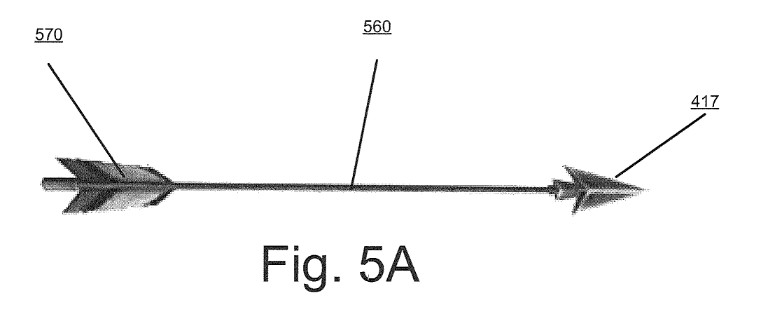

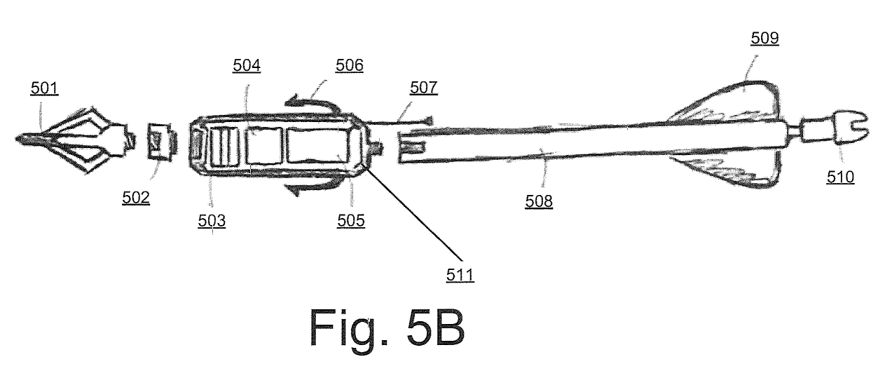

Referring first to FIG. 4A, the assembled broadhead 417 will be discussed. As illustrated in the figures, the broadhead 417 includes a plurality of blades 440, a tip 445 and a body 446. The broadhead 417 may be positioned on a shaft 560 of an arrow, which may include a fletching 570 on an end opposite the broadhead 417 as illustrated in FIG. 5A.

The broadhead 417 may include metal, such as steel. The broadhead typically has two to four sharp blades 440 (shown with three) that cause massive bleeding in the target. Their function is to deliver a wide cutting edge so as to kill as quickly as possible by cleanly cutting major blood vessels, and cause further trauma on removal. Any type of broadhead 417 may be used without departing from the scope of the present inventive concept. For example, although embodiments in FIGS. 4A-4E are illustrated having three blades, embodiments of the present inventive concept are not limited to this configuration. For example, the broadhead may have two or more than three blades without departing from the scope of the present inventive concept.

Fletchings 570are typically found at the back of the arrow shaft 560 and act as airfoils to provide a small amount of force used to stabilize the flight of the arrow. Fletchings 570 are typically designed to keep the arrow pointed in the direction of travel by strongly damping down any tendency to pitch or yaw. It will be understood that some embodiments may not include fletchings on the shaft 560.

The shaft 560 is the primary structural element of the arrow, to which the other components are attached. Traditional arrow shafts were made from lightweight wood, bamboo or reeds, while modern shafts may be made from aluminum, carbon fiber reinforced plastic, or any combination of materials. For example, a combination shaft may be made from an aluminum core wrapped with a carbon fiber. However, it will be understood that the shaft may be made of any material without departing from the scope of the present inventive concept.

A body 446 of a broadhead 417 having a tip 445 is illustrated in FIG. 4B and FIG. 4C illustrates the plurality of blades missing from the body 446 illustrated in FIG. 4B. FIG. 4D illustrates a locator collar 447 in accordance with some embodiments of the present inventive concept. In these embodiments, the locator collar 447 includes the position module 215/GPS module discussed with respect to FIG. 2A. The shaft 560 of the broadhead 417 is configured to break on impact with the target. The break deploys the locator collar 447 into the target, for example, a deer. Once the locator collar 447 is positioned in the target, the target can be tracked using the tracking module 225 that may be integrated with the hunter's smart phone in some embodiments.

Experiments of embodiments discussed with respect to FIGS. 4A through 5 have been performed. These experiments illustrate that the tracking systems in accordance with embodiments discussed herein are improved over conventional tracking systems. For example, over a distance of 30 yards, the accuracy of the broadhead was not affected by having the position module (GPS) integrated thereon. In other words, the presence of the GPS on the broadhead did not change the flight pattern of the arrow.

As discussed above, the position module 215 is not limited to a locator collar 447 discussed with respect to FIGS. 4A through 5. Is some embodiments, the position module 215 (GPS module) can be configured to be in a tip of the broadhead and to break away from the broadhead when it enters the target. In some embodiments, the GPS module can be positioned between the body of the broadhead and the blades. When the broadhead hits the target, the blades open and release the GPS module. In further embodiments, the GPS module may be included in the fletching so that if the arrow goes all the way through the target, the GPS module will remain in the target. It will be understood that some embodiments may have GPS modules positioned in more than one position on the arrow, for example, the arrow may have a locator collar as well as a GPS module in the fletching. Any combination of the various embodiments may be used without departing from the scope of the present inventive concept.

A more detailed block diagram of an arrow in accordance with some embodiments of the present inventive concept will be discussed with respect to FIG. 5B. As illustrated in FIG. 5B, an arrow may include an arrow head 501, an arrow head transmitter module adapter 502, a power supply 503, a GPS 504, a transmitter (HC-12 transceiver) 505, a hook 506, an antenna 507, a shaft 508, a fletching 509, and a nock 510. The power supply 503, the GPS and the transmitter 504 are provided in the transmitter module 511. In embodiments illustrated in FIG. 5B, the hook 506 allows the module to remain in the target so the target can be tracked. It will be understood that embodiments illustrated in FIG. 5B are provided as an example only and embodiments of the present inventive concept are not limited thereto.

Various of the details and dimensions of the components of the system in accordance with embodiments of the present inventive concept are provided in Table 2 of FIG. 6. Embodiments of the present inventive concept are not limited to the information provided in Table 2. Any GPS, transceiver, power supply and the like may be used as long as it complies with the functionality of embodiments discussed herein.

In some embodiments, the tracking module can be used in a wet environment, such as a lake or pond. In other words, the position module 215 may still be capable of transmitting when submerged in water. Similarly, some embodiments of the present inventive concept were still demonstrated to function when buried in the ground up to about 12 feet.

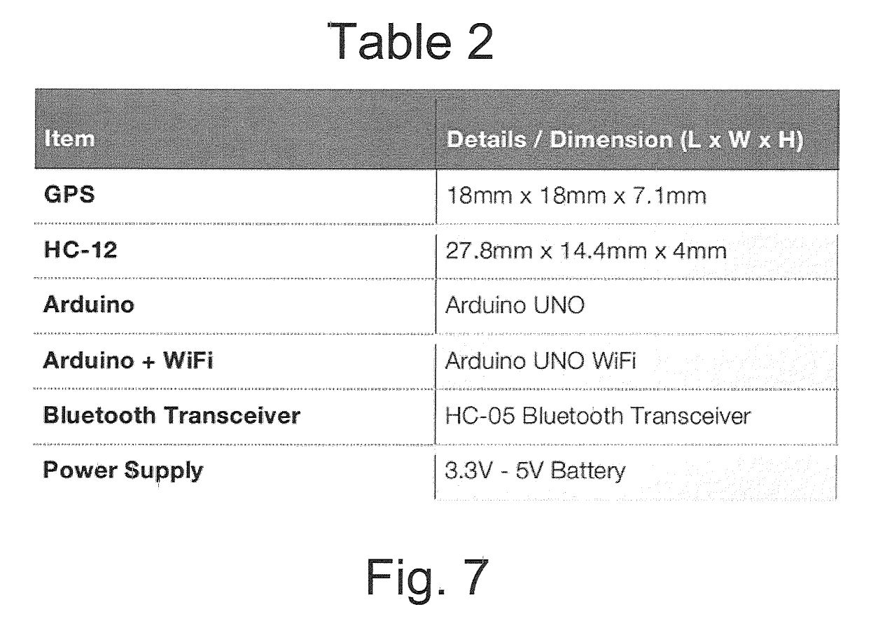

In particular, in embodiments used in a wet environment, the subject being tracked may be an aquatic animal, such as a fish as illustrated in FIG. 7. In these embodiments, when a fish 891 is caught, a position module 215 may be attached to the fish 819 before it is released. This may be useful for the fisherman and/or guides to locate where the fish are in a body of water (wet environment). The position module 215 may be attached to the fish 819 in any way known to those having skill in the art without departing from the scope of the present inventive concept. For example, the position module 215 may be attached using a biodegradable fastening, for example, a biodegradable hook with a barb at position A behind a dorsal fin of the fish 791. Similarly, the position module 215 may be attached to the tail of the fish at position B using a biodegradable zip tie. The zip tie may include a polyester material that is biodegradable. In other words, the zip tie will degrade over time and eventually release the position module 215 and free the fish. Embodiments of the present inventive concept are not limited to positions A and B as they are provided for example only. Thus, the fish 719 can be tracked for multiple days before the position module 215 falls off the fish.

In the drawings and specification, there have been disclosed exemplary embodiments of the inventive concept. However, many variations and modifications can be made to these embodiments without substantially departing from the principles of the present inventive concept. Accordingly, although specific terms are used, they are used in a generic and descriptive sense only and not for purposes of limitation, the scope of the inventive concept being defined by the following claims.

That which is claimed is:

1. A tracking system for tracking moving objects, the system comprising:
a position module configured to attach to an object that moves, the position module having a size that does not impede a purpose of the object that moves; and
a tracking module that communicates with the position module and receives position information associated with the position module attached to the object that moves.

2. The system of claim 1, wherein the position module is positioned on an arrow and wherein the position module is configured to attach to the object that moves when the arrow penetrates the object that moves.

3. The system of claim 2, wherein the object that moves is a living thing and wherein the position module further includes a tranquilizer to subdue the living thing.

4. The system of claim 2, wherein the position module comprises a collar that is configured to be positioned around a shaft of the arrow.

5. The system of claim 2, wherein the position module is positioned in a fletching of the arrow.

6. The system of claim 1, wherein the object that moves is a fish and wherein the position module is attached to the fish using a biodegradable fastening.

7. The system of claim 1, wherein the position module comprises a global positioning system (GPS) module.

8. The system of claim 1, wherein the object that moves is an object used in a sport.

9. The system of claim 1, wherein the system further includes a portable electronic device that communicates with the tracking module and wherein the position information is displayed on the portable electronic device.

10. The system of claim 9, wherein the position information is displayed on a map on the portable electronic device.

11. The system of claim 9, wherein the tracking module is provided by a software application on the portable electronic device.

12. A position module for use in a system for tracking moving objects, the position module comprising a housing having a size that does not impede a purpose of an object that moves and being configured to attach to the object that moves to provide position information associated with the object that moves.

13. The position module of claim 12, wherein the position module communicates the position information to a tracking module and wherein the tracking module receives the position information associated with the position module attached to the object that moves.

14. The position module of claim 12:
wherein the position module is positioned on an arrow; and
wherein the position module is configured to attach to the object that moves when the arrow penetrates the object that moves.

15. The position module of claim 14, wherein the object that moves is a living thing and wherein the position module further includes a tranquilizer to subdue the living thing.

16. The position module of claim 14, wherein the position module comprises a collar that is configured to be positioned around a shaft of the arrow.

17. The position module of claim 14, wherein the position module is positioned in a fletching of the arrow.

18. The position module of claim 12, wherein the object that moves is a fish and wherein the position module is attached to the fish using a biodegradable fastening.

19. The position module of claim 12, wherein the position module comprises a global positioning system (GPS) module.

20. The position module of claim 12, wherein the object that moves is an object used in a sport.
